(19) United States
(12) Patent Application Publication
(10) Pub. No.: US 2026/0099534 A1
(43) Pub. Date: Apr. 9, 2026

(54) SYSTEM AND METHOD FOR DOCUMENT PACKET GENERATION

(71) Applicant: SJD4L Enterprises, LLC, Dover, DE (US)

(72) Inventors: Steve Falk, Nashua, NH (US); Deena McKinley, Roxbury, CT (US); Jonas Fernandez, Wellington, FL (US); Maya Keeley, Silver Spring, MD (US); William Huster, Washington, DC (US); Sueah Kim, Dallas, TX (US)

(21) Appl. No.: 19/350,554

(22) Filed: Oct. 6, 2025

Related U.S. Application Data
(60) Provisional application No. 63/704,121, filed on Oct. 7, 2024.

(51) Int. Cl. G06F 16/38; G06F 16/31

(52) U.S. Cl. CPC G06F 16/38; G06F 16/31

(57) ABSTRACT

A computer system for generating packets of documents includes one or more processors; and non-transitory computer-readable storage media encoding instructions which, when executed by the one or more processors, causes the computer system to receive, from a computing device, a plurality of documents; tag each of the plurality of documents with one or more tags resulting in a plurality of tagged documents, store the plurality of tagged documents in a database, retrieve, from the database, one or more documents of the plurality of tagged documents, and provide, to the computing device, the packet including the one or more documents.

### BACKGROUND

To help manage digital documents, many entities and individuals upload documents to cloud servers as document data. Cloud servers provide more secure and reliable storage of important documents. However, cloud servers offer little organizational capabilities for quick searching and retrieval of documents when they are needed. Further, the databases used by cloud servers to store the document data require extensive computing resources to search. As a result of these necessary resources, computing devices take a substantial amount of time to locate the documents and provide them to the user device.

### SUMMARY

Examples provided herein are directed to packet generation.

According to one aspect, a computer system for generating packets of documents includes one or more processors; and non-transitory computer-readable storage media encoding instructions which, when executed by the one or more processors, causes the computer system to receive, from a computing device, a plurality of documents; tag each of the plurality of documents with one or more tags resulting in a plurality of tagged documents, store the plurality of tagged documents in a database based on the one or more tags to structure the database so documents with the same tags are stored in similar locations and searchable based on an indicated tag, and receive a template for a packet of documents. The template includes one or more required document types. The one or more processors are further caused to retrieve, from the database, one or more documents of the plurality of tagged documents based at least on one corresponding tag of the one or more tags matching the one or more required document types to form the packet. Retrieving the plurality of documents includes searching the database based on an associated tag. The one or more processors are further caused to provide, to the computing device, the packet including the one or more documents.

According to another aspect, an example method for generating packets of documents includes receiving, from a computing device, a plurality of documents, tagging each of the plurality of documents with one or more tags resulting in a plurality of tagged documents, storing the plurality of tagged documents in a database based on the one or more tags to structure the database so documents with the same tags are stored in similar locations and searchable based on an indicated tag, and receiving a template for a packet of documents. The template includes one or more required document types. The method further includes retrieving, from the database, one or more documents of the plurality of tagged documents based at least on one corresponding tag of the one or more tags matching the one or more required document types to form the packet. Retrieving the plurality of documents includes searching the database based on an associated tag. The method further includes providing, to the computing device, the packet including the one or more documents.

According to an additional aspect, a non-transitory computer-readable medium, has one or more instructions stored thereon that cause one or more processors to perform receiving, from a computing device, a plurality of documents, tagging each of the plurality of documents with one or more tags resulting in a plurality of tagged documents, storing the plurality of tagged documents in a database based on the one or more tags to structure the database so documents with the same tags are stored in similar locations and searchable based on an indicated tag, and receiving a template for a packet of documents. The template includes one or more required document types. The one or more processors are further caused to perform retrieving, from the database, one or more documents of the plurality of tagged documents based at least on one corresponding tag of the one or more tags matching the one or more required document types to form the packet. Retrieving the plurality of documents includes searching the database based on an associated tag. The one or more processors are further caused to perform providing, to the computing device, the packet including the one or more documents.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for packet generation.

FIG. 2 shows example components of a server device of the system of FIG. 1.

FIG. 3 shows additional example components of a backend module of the server device of FIG. 2.

FIG. 4 shows an example method for generating a packet of documents.

FIG. 5 shows an additional method for generating a packet of documents.

FIG. 6 shows an example packet template.

FIG. 7 shows an example packet for a mortgage application.

FIG. 8 shows an example document template.

FIG. 9 shows a user interface displaying stored documents in the database of FIG. 1.

FIG. 10 shows example physical components of the server device of FIG. 2.

### DETAILED DESCRIPTION

This disclosure generally relates to packets of documents generation.

Significant life events often require a collection of documents to complete the event. For example, filing a tax return or applying for a mortgage requires a significant number of documents that must be provided to the Internal Revenue Service or a bank, respectively. Managing the necessary documents can be cumbersome as the number of documents substantially grows.

Traditional online storage systems store documents and other files for future access. A user can upload a document and find the document at a later time for future use. A user can search through any created files in their cloud storage to attempt to find a document that was uploaded many years ago. For example, a mortgage application may require a user's past tax documents that cover the past three years, such as a W-2 form. A user will then have to manually search through their self-created folders to find all the tax documents from the past three years.

The present disclosure describes embodiments of a packet generation system. The packets include documents that may be required for a transaction or life event that requires documents from past years. For example, many applications, such as mortgage applications and insurance applications, require a number of tax documents and identification documents (e.g., passport, driver's license, etc.) to complete. The packet generation system automatically searches a user's stored documents and automatically populates the packet with the needed documents.

For example, a mortgage application may require a mortgage statement, tax return, driver's license, employment contact, pay stubs, and additional documents. The packet generation system searches for documents with relevant tags to add to the packet. Once the packet has been generated, the packet can be provided to a user device for access, such as to print. In some embodiments, the packet is sent to a third-party entity, such as a bank, that requires the documents.

The packet generation system is configured to tag documents that are uploaded from a computing device. As a user uploads documents to the packet generation system for storage, the packet generation system can add tags to the document for future retrieval. For example, the user may upload a copy of their W-2 for a year. The packet generation system receives the document and tags the document as a W-2 for future searching. Further, a corresponding year may be added to the document as well. In some embodiments, tags for each document are received from a computing device.

In addition, the packet generation system utilizes templates for assembling stored documents. The templates require documents that are well known to be required for a corresponding purpose. The packet generation system stores templates that are applicable to most use cases and quickly organizes required documents for an application or other purpose. In some embodiments, the templates can be received from third-party entities or services. In some embodiments, the packet templates are created based on industry standards or business logic.

The packet generation system also enhances document storage and management. Rather than manual searching through numerous folders, the packet generation system automatically filters documents when generating a requested packet. Further, it creates structure to the database that stores the documents by tagging each document with appropriate tags.

In an example, the packet generation system may receive a request for a packet to apply for a mortgage. The packet generation system filters documents associated with a user account to find relevant documents fort the mortgage application. The packet generation system then organizes or classifies the documents as associated with the requested packet. The documents are then provided to the requesting device as classified for the mortgage application.

These discussed features improve document storage systems. Documents can be automatically retrieved and added to a packet using the document tags without searching through numerous folders that may or may not have relevant documents. The document tags result in faster searching through the document storage and generation of packets. In addition, the inherent structure of the database as a result of tagging the documents results in automatic filtering of documents. The packet generation system can find relevant documents without searching the entire database due to the filtering, thus, conserving computing resources. Thus, the described document storage system creates a new, non-conventional way of structuring and indexing data to enable faster and more efficient retrieval.

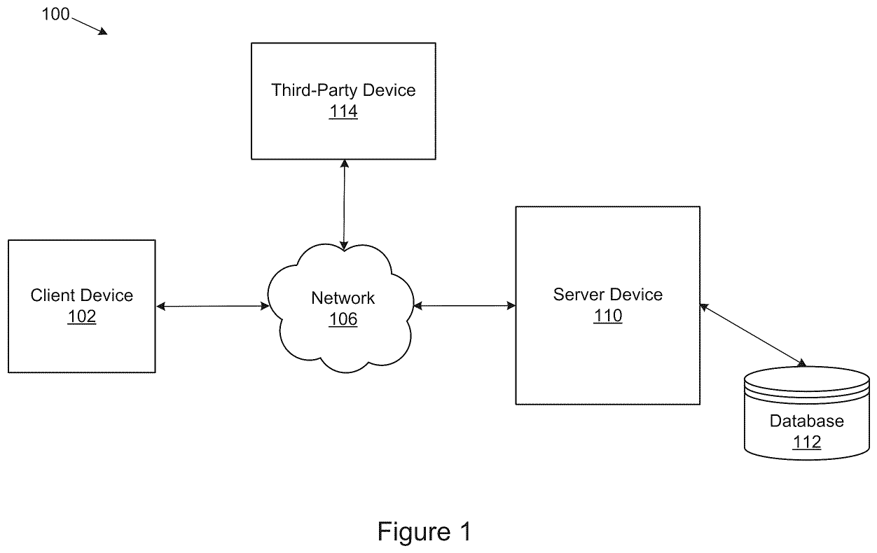

FIG. 1 shows an example system 100 for packet generation. In this embodiment, the system 100 includes a server device 110 that connects through a network to a client device 102 and a third-party device 114. The server device 110 also connects to a database 112.

The server device 110 generates packets of documents. Once the server device 110 receives a request for packet generation, the server device retrieves the necessary document and forms the requested packet. Further, the server device 110 also manages document storage. Any received documents are stored within the database 112 with appropriate tags. The server device 110 can then efficiently search and retrieve the documents at a future date when a packet requires them.

In addition, the server device 110 tags the received documents with the tags that are relevant to the document. Tags can include a type of document. The type of document indicates what a document is or a description of the contents of a document. The tags may also include a year or date for the document. In some examples, the tags are a general category of the document. The tags may also include a relationship.

In some embodiments, the server device 110 automatically tags the documents. In some embodiments, the server device 110 receives tags from the client device 102. The server device 110 then tags the documents with the indicated tags received from the client device 102. In some embodiments, the received documents include metadata indicating appropriate tags for the document.

The client device 102 is a computing device that is accessible by a user. For example, the client device 102 may be a smartphone, tablet, or computer that the user accesses services offered by the server device 110. The client device 102 also receives documents. In some embodiments, the client device 102 obtains a portable document format (“pdf”) version of a document from another client device. In some embodiments, the client device 102 scans the document or takes a photo of the document.

Also, the client device 102 receives packets that are generated by the server device 110. Once the server device 110 generates a packet, the server device 110 may send the packet to the client device 102. The client device 102 may then display or print the packet. In some embodiments, the client device 102 may send the packet to an external computing device, such as to the third-party device 114.

The third-party device 114 may be a third-party server that offers certain features and functions. For example, the third-party device 114 may offer functions, such as accessing certain data for a website, that the server device 110 can use. The server device 110 may access the functions of the third-party device 114 through an application programming interface (“API”). In some embodiments, the third-party device 114 is an entity's server that allows the client device 102 to access an associated account. For example, the third-party device 114 provide access to a bank account. The client device 102 or the server device 110 can send packets of documents to the third-party device 114. In an example, the packet is sent to the third-party service as a mortgage application containing all the necessary documents.

The database 112 stores documents for the server device 110. In addition, the database 112 can store packets and template data, such as packet templates and/or document templates. In some embodiments, the database 112 is structured so documents with the same tags are stored in similar locations and searchable based on an indicated tag. In addition, the database 112 can store other account data, such as usernames, passwords, or emails. Further, the database 112 can be a relational database. Sequence query language (“SQL”) can be used to query data from the database 112. In some embodiments, the database 112 can be a non-relational database. In some embodiments, the database 112 is structured based on other aspects of the documents as well.

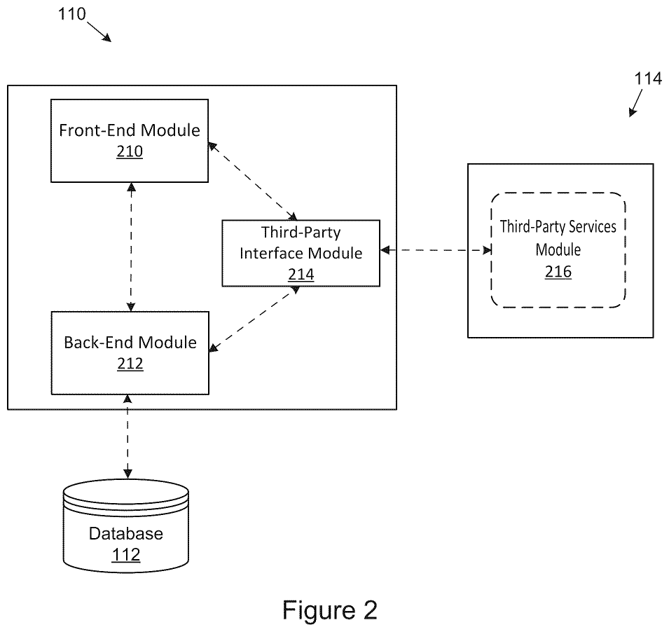

FIG. 2 shows example components of the server device 110 of the system 100. The server device 110 includes a front-end module 210, a back-end module 212, and a third-party interface module 214. The third-party device 114 includes a third-party services module 216.

The front-end module 210 manages access to the server device 110, and the front-end module 210 also handles the presentation layer of the functions and services hosted on the server device 110. For example, the front-end module 210 manages access to a user account of the server device 110. The front-end module 210 may verify received credentials from the client device 102 and determine which user account the client device 102 can access. The user account may include access to stored documents within the database 112. Further, the front-end module 210 provides data files for presentation of the user's account data and other features provided by the server device 110.

In addition, the front-end module 210 serves static files, such as Hypertext Markup Language (“HTML”), Cascading Style Sheets (“CSS”), JavaScript, images, and other assets that make up the user interface of a web application. It efficiently delivers these files to users' browsers when they request a webpage. The front-end module 210 also handles client-side routing where a browser of the client device 102 dynamically updates the content of a page without requiring a full page reload. The front-end module 210 can manage this process by handling requests for different routes to different URLs and serving the appropriate files or data. The front-end module 210 also caches frequently used files, forward requests from the client device 102 to an API that connects to the third-party device 114 and perform server-side rendering.

In this embodiment, the back-end module 212 processes data and performs the previously discussed functions regarding generating packets and storing data. The back-end module 212 tags documents. Further, the back-end module 212 manages or generates packet templates. The back-end module 212 also searches for documents, transmits packets, and classifies packets.

The back-end module 212 also handles the storage, retrieval, and manipulation of data within a database or other data store. Further, the back-end module 212 may implement business logic including core logic and rules that define how the server device 110 behaves and responds to user requests. Further, the back-end module 212 includes endpoint APIs for communication to the front-end module 210. The back-end module 212 may perform other background tasks as well.

The third-party interface module 214 communicates with the third-party services module 216 to provide access to the services and functions offered by the third-party device 114. The third-party interface module 214 may be an API that accesses other applications, such as the third-party services module 216. The third-party services module 216 may performs services or functions such as payment management, logs, emailing, or error logging.

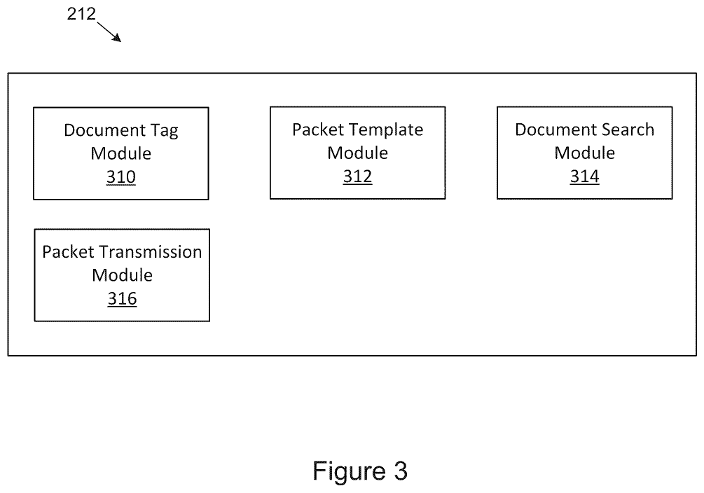

FIG. 3 shows additional example components of the back-end module 212. The back-end module 212 includes a document tag module 310, a packet template module 312, a document search module 314, and a packet transmission module 316.

The document tag module 310 tags received documents. As the server device 110 receives documents, the document tag module 310 adds tags to the document. Then, the document tag module 310 stores the document with the associated tags in the database 112. The tags can be a document type, a document year, a general category, or a user relationship. For example, the type of document may be a 1099, a tax bill, a driver's license, expense receipts, a divorce decree, a death certificate, a passport, a W-2, a purchase of sale agreement, a contract, a loan document, a policy, a mortgage statement, or other type of document. In some embodiments, the tag may be an associated year for a W-2 form. The tags may also include the general category, such as a financial document, identification document, an insurance document, a legal document, or a tax document. In some embodiments, the tag indicates a relationship to the user, which may be self, parent, child, or spouse.

In some embodiments, the document tag module 310 determines tags for the document. The document tag module 310 may scan the document and determine the document's purpose. For example, the document tag module 310 may use optical character recognition (“OCR”) to scan the documents. In some embodiments, the document tag module 310 inputs the document into a machine learning model that is trained to recognize a document's subject matter and provide a description of the document or possible tags of the document. The document tag module can 310 can then add the tags to the documents once they are determined. In some embodiments, the document tag module 310 adds the tags as metadata.

In some embodiments, the document tag module 310 receives tags from the client device 102 for an uploaded document. Once the document tag module 310 receives the document and associated tags from the client device 102, the document tag module adds the tags to the document.

The packet template module 312 provides packet templates that can be used to assemble documents. Each template can be used as a guide for assembling documents. For example, the packet template may show documents required for a mortgage application. Further, each packet template can be pre-generated so the client device 102 selects the packets to automatically assemble the shown documents. The documents are classified with the generated packet. The documents can then be assembled to form the packet.

In some embodiments, the packet template module 312 receives templates. The packet template module 312 may receive templates from the third-party device 114. For example, the third-party device 114 may be operated by a bank, and the bank uploads a packet template to the packet template module 312 that includes the necessary documents the bank requires for a loan. In some embodiments, the packet template module 312 generates the packet template. The packet template module 312 may receive input describing the packet and then generate likely required documents for the purpose of the packet. The packet template module 312 may also receive required documents from an external device not shown. The required documents are then classified as the packet template. The document search module 314 assembles the documents into the packet.

The document search module 314 searches for documents in the database 112. Also, the document search module 314 finds documents that a selected packet requires. Further, the document search module 314 accesses the database 112 to search for the indicated documents stored in the database 112. Once the documents are found, the document search module 314 gathers the documents and provides the documents for organizing into the packet.

In some embodiments, the document search module 314 searches the database 112 for the indicated documents using tags. For example, the document search module 314 may search for documents tagged with an indicated relationship, such as self. The document search module 314 may also search for documents with an indicated category. Moreover, the document search module 314 may search for documents tagged with an indicated date, year, or year plus-or-minus an offset number. The document search module 314 may further refine the search. For example, the document search module 314 may then search for documents tagged with an indicated document type. In some embodiment, the document search module 314 uses a SQL query to search the database 112. In some embodiments, the document search module 314 filters the documents based on the indicated tags. In some embodiments, the document search module 314 searches the database 112 using a key-value pair. In some embodiments, the document search module 314 determines an explanation for not providing a document. Further, the explanation may be provided to the client device 102.

The packet transmission module 316 transmits the packet to another device. Further, packet transmission module 316 transmits the assembled documents that are classified as part of the packet to a selected destination. The packet transmission module 316 may transmit the packets with the associated documents to the client device 102 or the third-party device 114. In addition, the packet transmission module 316 may transmit the packet over a secure and encrypted connection.

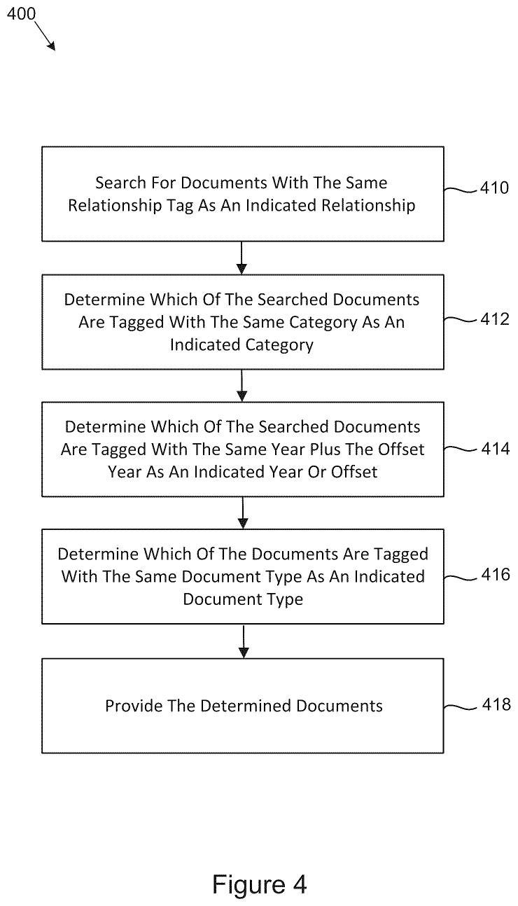

FIG. 4 shows an example method 400 for generating a packet of documents. In this embodiment, the method 400 includes an operation 410, an operation 412, an operation 414, an operation 416, and an operation 418. Some or all of the listed operations of the method 400 may be performed by the server device 110. In some embodiments, other devices may perform some or all of the operations of the method 400.

At the operation 410, documents are searched. The documents may have the same relationship as an indicated relationship tag. For example, the documents may be tagged with the “self” tag for a user account. The documents may include all documents that are tagged with the “self” tag.

At the operation 412, the searched documents with the same category as an indicated tag category are determined. The searched documents are limited by the previous search for a relationship tag, such as “self.” The documents with a desired tag category are then determined. For example, the documents with a category of “financial” may be filtered so only those documents with the financial tag category are within the search.

At the operation 414, the searched documents tagged with the same year or the same offset as an indicated year or offset are determined. For example, a packet may require documents from 2019. Documents that are not tagged with “self” and “financial” as indicated in the previous steps and also tagged with 2019 are filtered out. In some embodiments, an offset is included. For example, the packet may be for 2020 and require financial documents from the past three years. The year is set to 2020, and the offset is set to three. All financial documents within that timeframe, i.e., 2019, 2018, and 2017, are determined to still be within the scope of the search and are not filtered out.

At the operation 416, it is determined which of the documents are tagged with the same document type as an indicated document type. The remaining documents after the above steps are further filtered down to just the documents with a desired type. For example, the server device 110 may search for documents that have a relationship tag of self and narrow down to documents that are financial for the year 2019 and are a W-2.

At the operation 418, the determined documents are provided as a packet. In some embodiments, the determined documents are provided to the client device 102. The method 400 may include assembling the documents into the packet. In some embodiments, the method 400 includes completing additional searches to find additional documents.

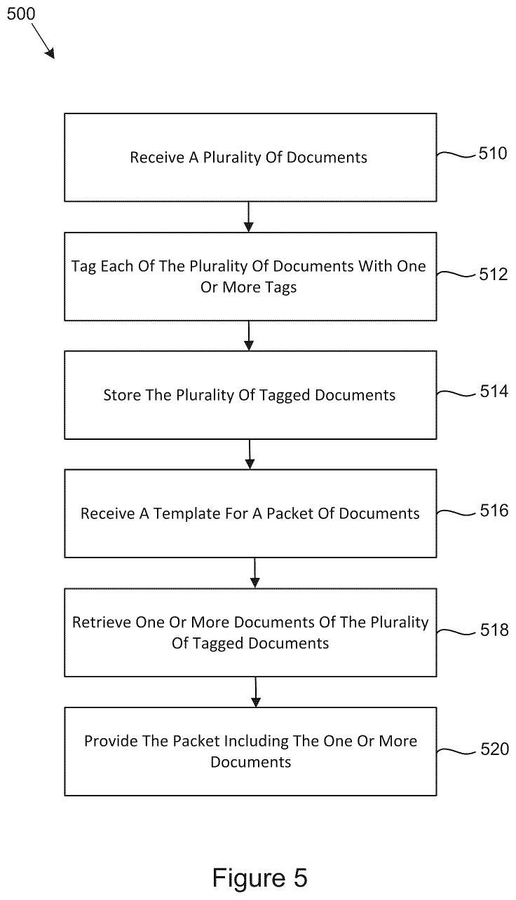

FIG. 5 shows an example method 500 for generating packets of documents. In this embodiment, the method 500 includes an operation 510, an operation 512, an operation 514, an operation 516, an operation 518, and an operation 520. Some or all of the listed operations of the method 500 may be performed by the server device 110. In some embodiments, other devices may perform some or all of the operations of the method 500.

At the operation 510, a plurality of documents is received. The plurality of documents may include financial documents, identifications (e.g., passport, driver's license, etc.), legal documents, or other significant documents to a user. The documents may be associated with a user account, which is accessible by the client device 102. Further, the plurality of documents may be received from the client device 102. In an example, the server device 110 receives a W-2 for a user dated 2019.

At the operation 512, each of the plurality of documents are tagged with one or more tags. The tags may be a type of document, a relationship to the user, a year or other date information, or a category. In some embodiments, the tagging each of the documents includes determining tags for each of the plurality of documents. In some embodiments, the tags include a document type. This determination may include scanning the documents or inputting the documents into a machine learning model to determine appropriate tags. In some embodiments, the tags are received from the client device 102. The client device 102 provides suggested tags for each of the plurality of documents. Then, each of the plurality of documents is tagged with the suggested tags. Continuing the previous example, the document is tagged with a W-2 tag, a financial document tag category, a self-relationship tag, and a year 2019 tag.

At the operation 514, the plurality of tagged documents is stored. The documents may be stored in the database 112 based on the tags of each of the plurality of documents. Also, the database is structured so documents with the same tags are stored in similar locations and searchable based on an indicated tag. Further, the documents may be associated with a user account when stored. For example, the server device stores the W-2 stored in the database 112 and associates the W-2 with a user account that is accessible by the client device 102.

At the operation 516, a template for a packet of documents is received. The packet may be for an application such as a loan from a bank. In some embodiments, the template is received from the third-party device 114. In some embodiments, the template is received from a different device. In some embodiments, the template is generated according to received inputs that indicate document types required for the packet. In some embodiments, the template for the packet includes one or more required document types.

At the operation 518, one or more documents of the plurality of tagged documents are retrieved. The one or more documents may be retrieved based on the received template. Further, each of the documents may be retrieved based at least on one corresponding tag of the one or more tags matching the one or more required document types to form the packet. Retrieving the plurality of documents may include searching the database based on an associated tag or tag category. For example, the loan application may require a W-2. Accordingly, the previously tagged and stored W-2 is retrieved. In some embodiments, the one or more documents are retrieved based at least on one corresponding tag of the one or more tags matching the one or more required document types to form the packet.

At the operation 520, the packet including the one or more documents is provided. The packet may be provided to the client device 102 or the third-party device 114. In some embodiments, the packet is stored in the database 112.

In some embodiments, the method 500 includes determining two or more documents include a tag that matches the document type and selecting a latest document with the latest tagged date. In some embodiments, the one or more tags include document year, W2, tax return, driver's license, and passport. In some embodiments, the method 500 further includes determining an offset year for each of the plurality of tagged documents based on the document year. In some embodiments, tagging each of the plurality of tagged documents includes receiving, from the computing device, a suggested tag. In some embodiments, the one or more tags includes a relationship to the user account. In some embodiments, the relationship self, spouse, child, or parent.

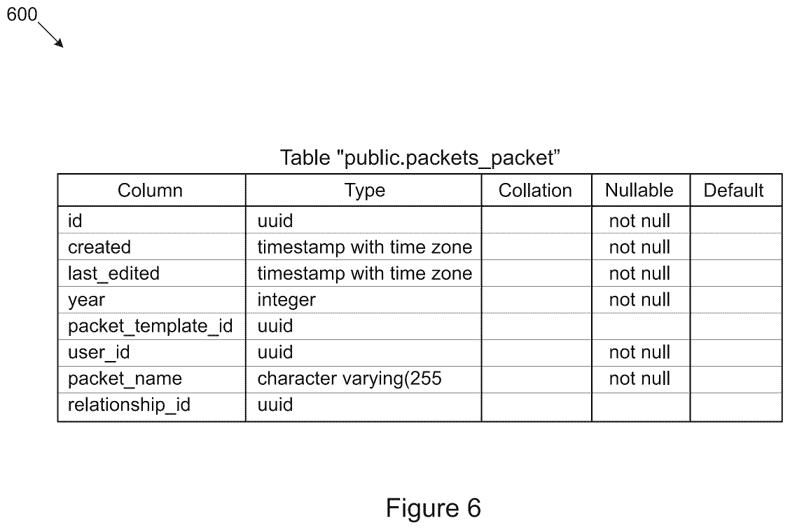

FIG. 6 shows an example packet parameter table 600. The packet parameter table 600 includes parameters to form a packet template. The shown parameters form the data file format for the packet templates that are stored. In this embodiment, the packet parameter table 600 includes a packet identification (“ID”) and packet template ID, an associated user ID, and a relationship ID. These fields can be filled to make the packet more accessible. For example, the packet ID can be used to search for packet template when there are many packet templates. The packet parameter table 600 also includes a timestamp for when the packet was created and last edited. Further, the packet parameter table 600 can be named. The packet parameter table 600 includes other fields as well.

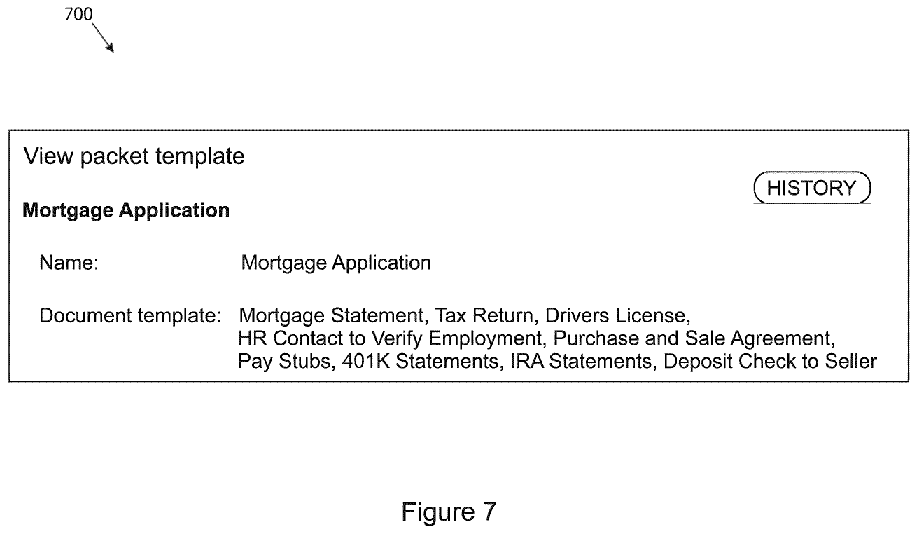

FIG. 7 shows an example packet template 700 for a mortgage application. The example packet template 700 requires the document types: mortgage statement, tax return, driver's license, HR contact to verify employment, purchase and sale agreement, pay stubs, 401K statements, IRA statements, and a deposit check to seller.

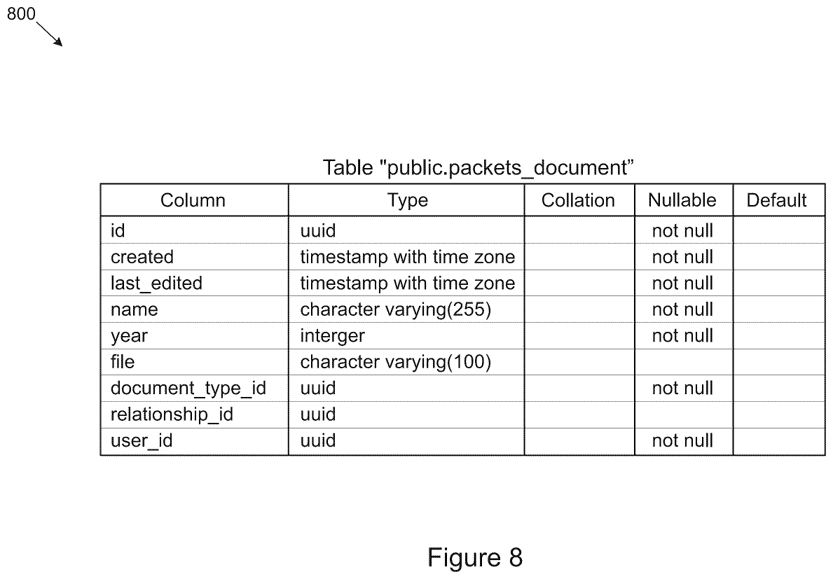

FIG. 8 shows an example document parameter table 800. The document parameter table includes parameters to form a document. The shown parameters form the data file format for the documents that are stored in the database 112. In this embodiment, the document parameter table 800 includes fields for identifying the documents. These fields may be configurable tags for the uploaded document. For example, the document parameter table 800 includes an ID a created and last edit timestamp, a name, a year, a file, a document type, a relationship, and a user ID. The document type, year, relationship, and others may be tags for the document. In some embodiments, the document parameter table 800 may include other fields as well.

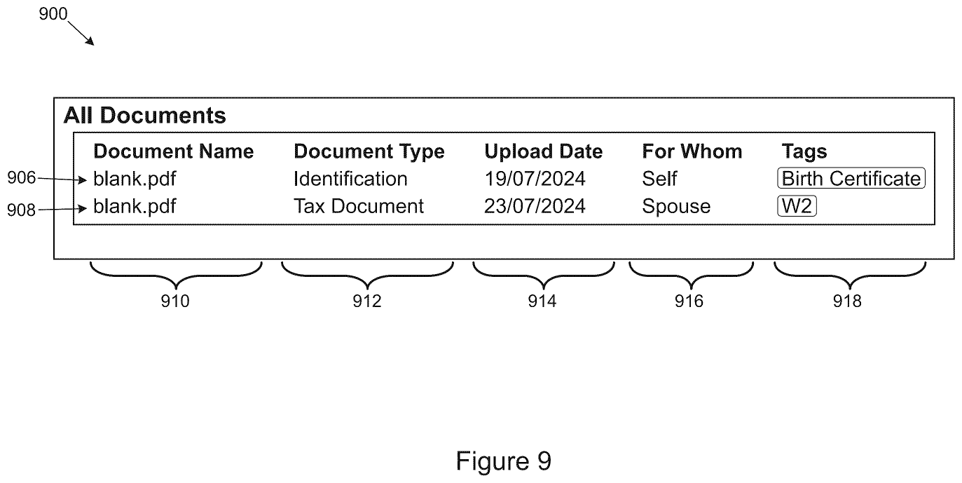

FIG. 9 shows a user interface 900 displaying stored documents in the database 112. In this embodiment, the user interface 900 shows stored a document 906 and a document 908 stored in the database 112 and associated with a user account. The data fields include a document name 910, a document category 912, a document upload date 914, a relationship tag 916, and additional tags 918.

Each of the rows of the user interface 900 correspond to the document 906 or the document 908, respectively. The document 906 is a birth certificate as indicated by the additional tags 918. Further, it is for the user as shown by the relationship tag 916. The document 906 was uploaded on Jul. 19, 2024. Further, it falls under the tag category “Identification.” The document 908 is a W-2 that is for the user's spouse. The document 908 was uploaded on Jul. 23, 2024 and falls under “Tax Document” category. Additional documents can be shown and included. Further, the documents can be filtered based on any of the shown tags. Other tags, such as an associated year may also be displayed.

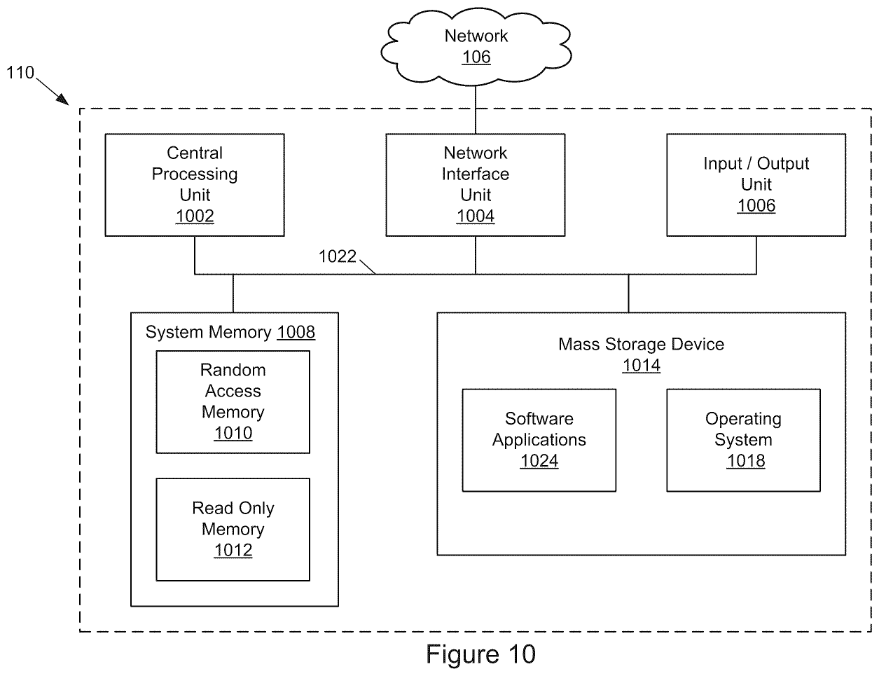

As illustrated in the embodiment of FIG. 10, the example server device 110, which provides the functionality described herein, can include at least one central processing unit (“CPU”) 1002, a system memory 1008, and a system bus 1022 that couples the system memory 1008 to the CPU 1002. The system memory 1008 includes a random-access memory (“RAM”) 1010 and a read-only memory (“ROM”) 1012. A basic input/output system containing the basic routines that help transfer information between elements within the server device 110, such as during startup, is stored in the ROM 1012. The server device 110 further includes a mass storage device 1014. The mass storage device 1014 can store software instructions and data. A central processing unit, system memory, and mass storage device similar to that shown can also be included in the other computing devices disclosed herein.

The mass storage device 1014 is connected to the CPU 1002 through a mass storage controller (not shown) connected to the system bus 1022. The mass storage device 1014 and its associated computer-readable data storage media provide non-volatile, non-transitory storage for the server device 110. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 110.

According to various embodiments of the invention, the server device 110 may operate in a networked environment using logical connections to remote network devices through network 106, such as a wireless network, the Internet, or another type of network. The server device 110 may connect to network 106 through a network interface unit 1004 connected to the system bus 1022. It should be appreciated that the network interface unit 1004 may also be utilized to connect to other types of networks and remote computing systems. The server device 110 also includes an input/output controller 1006 for receiving and processing input from a number of other devices, including a touch user interface display screen or another type of input device. Similarly, the input/output controller 1006 may provide output to a touch user interface display screen or other output devices.

As mentioned briefly above, the mass storage device 1014 and the RAM 1010 of the server device 110 can store software instructions and data. The software instructions include an operating system 1018 suitable for controlling the operation of the server device 110. The mass storage device 1014 and/or the RAM 1010 also store software instructions and applications 1024, that when executed by the CPU 1002, cause the server device 110 to provide the functionality of the server device 110 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for generating packets of documents, the computer system comprising:
one or more processors; and
non-transitory computer-readable storage media encoding instructions which, when executed by the one or more processors, causes the computer system to:
receive, from a computing device, a plurality of documents;
tag each of the plurality of documents with one or more tags resulting in a plurality of tagged documents;
store the plurality of tagged documents in a database based on the one or more tags to structure the database so documents with the same tags are stored in similar locations and searchable based on an indicated tag;
receive a template for a packet of documents, the template including one or more required document types;
retrieve, from the database, one or more documents of the plurality of tagged documents based at least on one corresponding tag of the one or more tags matching the one or more required document types to form the packet, wherein retrieve the plurality of documents includes searching the database based on an associated tag; and
provide, to the computing device, the packet including the one or more documents.

2. The computer system of claim 1, wherein the instructions further cause the computer system to:
determine two or more documents include a tag that matches a document type; and
select a latest document with a latest tagged date.

3. The computer system of claim 1, wherein the one or more tags include document year, W2, tax return, driver's license, and passport.

4. The computer system of claim 3, wherein the instructions further cause the computer system to:
determine an offset year for each of the plurality of tagged documents based on the document year.

5. The computer system of claim 1, wherein tag each of the plurality of tagged documents includes receive, from the computing device, a suggested tag.

6. The computer system of claim 1, wherein the one or more tags includes a relationship to a user account.

7. The computer system of claim 6, wherein the relationship includes self, spouse, child, or parent.

8. A method for generating packets of documents, the method comprising:
receiving, from a computing device, a plurality of documents;
tagging each of the plurality of documents with one or more tags resulting in a plurality of tagged documents;
storing the plurality of tagged documents in a database based on the one or more tags to structure the database so documents with the same tags are stored in similar locations and searchable based on an indicated tag;
receiving a template for a packet of documents, the template including one or more required document types;
retrieving, from the database, one or more documents of the plurality of tagged documents based at least on one corresponding tag of the one or more tags matching the one or more required document types to form the packet, wherein retrieving the plurality of documents includes searching the database based on an associated tag; and
providing, to the computing device, the packet including the one or more documents.

9. The method of claim 8, further comprising:
determining two or more documents include the same tag that matches a document type; and
selecting a latest document with a latest tagged date.

10. The method of claim 8, wherein the one or more tags include document year, W2, tax return, driver's license, and passport.

11. The method of claim 10, further comprising:
determining an offset year for each of the plurality of tagged documents based on the document year.

12. The method of claim 8, wherein tagging each of the plurality of tagged documents includes receiving, from the computing device, a suggested tag.

13. The method of claim 8, wherein the one or more tags includes a relationship to a user account.

14. The method of claim 13, wherein the relationship includes self, spouse, child, or parent.

15. A non-transitory computer-readable medium, having one or more instructions stored thereon that cause one or more processors to perform:
receiving, from a computing device, a plurality of documents;
tagging each of the plurality of documents with one or more tags resulting in a plurality of tagged documents;
storing the plurality of tagged documents in a database based on the one or more tags to structure the database so documents with the same tags are stored in similar locations and searchable based on an indicated tag;
receiving a template for a packet of documents, the template including one or more required document types;
retrieving, from the database, one or more documents of the plurality of tagged documents based at least on one corresponding tag of the one or more tags matching the one or more required document types to form the packet, wherein retrieving the plurality of documents includes searching the database based on an associated tag; and
providing, to the computing device, the packet including the one or more documents.

16. The non-transitory computer-readable medium of claim 15, wherein the one or more instructions further cause the one or more processors to perform:
determining two or more documents include the same tag that matches a document type; and
selecting a latest document with a latest tagged date.

17. The non-transitory computer-readable medium of claim 15, wherein the one or more tags include document year, W2, tax return, driver's license, and passport.

18. The non-transitory computer-readable medium of claim 17, wherein the one or more instructions further cause the one or more processors to perform:
determining an offset year for each of the plurality of tagged documents based on the document year.

19. The non-transitory computer-readable medium of claim 15, wherein tagging each of the plurality of tagged documents includes receiving, from the computing device, a suggested tag.

20. The non-transitory computer-readable medium of claim 15, wherein the one or more tags includes a relationship to a user account.
